(19) United States
(12) Patent Application Publication
(10) Pub. No.: US 2018/0230815 A1
(43) Pub. Date: Aug. 16, 2018

(54) Turbine airfoil with thin trailing edge cooling circuit

(71) Applicant: Florida Turbine Technologies, Inc., Jupiter, FL (US)

(72) Inventor: Russell B. Jones, North Palm Beach, FL (US)

(21) Appl. No.: 15/433,332

(22) Filed: Feb. 15, 2017

(51) Int. Cl. F01D 5/18; F01D 9/02; F01D 25/12

(52) U.S. Cl. CPC F01D 5/187; F01D 9/02; F05D 2240/304; F05D 2220/32; F01D 25/12

(57) ABSTRACT

A cooling circuit for a trailing edge region of a turbine airfoil where the trailing edge is relatively thin, the cooling circuit having a series of aftward flowing channels alternating with a series of forward flowing cooling channels, and a turn channel at the trailing edge of the airfoil where the aftward flowing channels flow into the forward flowing channels in order to keep the airfoil thin and to provide cooling to the thin trailing edge. Spanwise extending cooling supply channels and cooling return channels are connected to the aftward and forward flowing channels and positioned to allow for a thinner airfoil.

### CROSS-REFERENCE TO RELATED APPLICATIONS

None.

### GOVERNMENT LICENSE RIGHTS

None.

### BACKGROUND OF THE INVENTION

### Field of the Invention

The present invention relates generally to a small aero gas turbine engine, and more specifically to a thin turbine airfoil with a trailing edge cooling circuit.

### Description of the Related Art Including Information Disclosed Under 37 CFR 1.97 and 1.98

Turbine airfoils such as rotor blades and stator vanes require cooling to prevent thermal damage. Turbine airfoils require thin trailing edges in order to improve efficiency. However, thin trailing edges are difficult to form with cooling passages because the space between the pressure side and the suction side walls is very thin. Therefore, improvements in trailing edge cooling circuits that allow for thin walls will improve thermal life as well as efficiency.

### BRIEF SUMMARY OF THE INVENTION

A trailing edge cooling circuit for a turbine airfoil such as a rotor blade or a stator vane. The TE cooling circuit includes two chordwise extending channels that alternate in the airfoil spanwise (radial) direction. Cooling air from an adjacent cooling air channel flow into the aft flowing channels to provide cooling to the adjacent sections of the TE and then flows into the forward flowing channels to provide cooling to these adjacent sections of the TE. Each of the aft flowing and forward flowing channels includes holes at the end of the channels to connect the adjacent channels to produce the series flow from aft flowing direction to forward flowing direction. Cooling air is thus delivered to the plurality of aft flowing channels, then flow through the holes at the ends of the channels and into the forward flowing channels. The forward flowing channels can discharge the spent cooling air out tip hole or pass back into a channel within the airfoil.

A trailing edge cooling circuit for a turbine airfoil having alternating chordwise extending cooling air channels that alternate in the spanwise direction, where cooling air flows into first chordwise channels to cool the adjacent section of the trailing edge, and then flow into the second chordwise channels to provide cooling to that adjacent section of the trailing edge. The cooling air from the second channels can be discharge out tip hole or into another channel within the airfoil.

### BRIEF DESCRIPTION OF THE SEVERAL VIEWS OF THE DRAWINGS

FIG. 1 shows a thin trailing edge cooling circuit for a turbine airfoil according to a first embodiment of the present invention.

FIG. 2 shows a cutaway view of the thin trailing edge cooling circuit of FIG. 1.

FIG. 3 shows a flow diagram of the thin trailing edge cooling circuit of FIG. 1.

FIG. 4 shows a second embodiment of the thin trailing edge cooling circuit of FIG. 1 with trailing edge exit holes.

FIG. 5 shows a third embodiment of the thin trailing edge cooling circuit of FIG. 1 with separate supply and return channels.

FIG. 6 shows a flow diagram of the FIG. 4 thin trailing edge cooling circuit.

FIG. 7 shows a flow diagram of the FIG. 5 thin trailing edge cooling circuit.

FIG. 8 shows a thin trailing edge cooling circuit for a turbine airfoil according to a second embodiment of the present invention.

FIG. 9 shows a cutaway view of the thin trailing edge cooling circuit of FIG. 8.

FIG. 10 shows a flow diagram of the thin trailing edge cooling circuit of FIG. 8.

FIG. 11 shows a second embodiment of the thin trailing edge cooling circuit of FIG. 4 with trailing edge exit holes.

FIG. 12 shows a third embodiment of the thin trailing edge cooling circuit of FIG. 4 with separate supply and return channels.

FIG. 13 shows a flow diagram of the FIG. 11 thin trailing edge cooling circuit.

FIG. 14 shows a flow diagram of the FIG. 12 thin trailing edge cooling circuit.

FIG. 15 shows a thin trailing edge cooling circuit for a turbine airfoil according to a third embodiment of the present invention.

FIG. 16 shows a cutaway view of the thin trailing edge cooling circuit of FIG. 15.

FIG. 17 shows a flow diagram of the thin trailing edge cooling circuit of FIG. 15.

FIG. 18 shows a second embodiment of the thin trailing edge cooling circuit of FIG. 15 with trailing edge exit holes.

FIG. 19 shows a third embodiment of the thin trailing edge cooling circuit of FIG. 15 with separate supply and return channels.

FIG. 20 shows a flow diagram of the FIG. 18 thin trailing edge cooling circuit.

FIG. 21 shows a flow diagram of the FIG. 19 thin trailing edge cooling circuit.

FIG. 22 shows a thin trailing edge cooling circuit for a turbine airfoil according to a fourth embodiment of the present invention.

FIG. 23 shows a ceramic core used to cast the thin trailing edge cooling circuit of FIG. 22.

FIG. 24 shows a flow diagram of the thin trailing edge cooling circuit of FIG. 22.

FIG. 25 shows a cutaway view from the back side of the thin trailing edge cooling circuit with exit holes of FIG. 22.

FIG. 26 shows a cutaway view from the back side of the thin trailing edge cooling circuit with separate supply and return channels of FIG. 22.

FIG. 27 shows a flow diagram for the thin trailing edge cooling circuit of FIG. 25.

FIG. 28 shows a flow diagram for the thin trailing edge cooling circuit of FIG. 26.

### DETAILED DESCRIPTION OF THE INVENTION

The present invention is a cooling circuit for a trailing edge of a turbine airfoil having a thin trailing edge. A ceramic core having the shape of the trailing edge region cooling circuit for the thin trailing edge airfoil is used to cast with the airfoil. Several embodiment of the present invention are disclosed in which cooling air from a supply channel flows aftward to the trailing edge, turns and then flows forward to a return channel so that both the pressure side wall and the suction side wall of the trailing edge region of the airfoil as well as the trailing edge are all cooled.

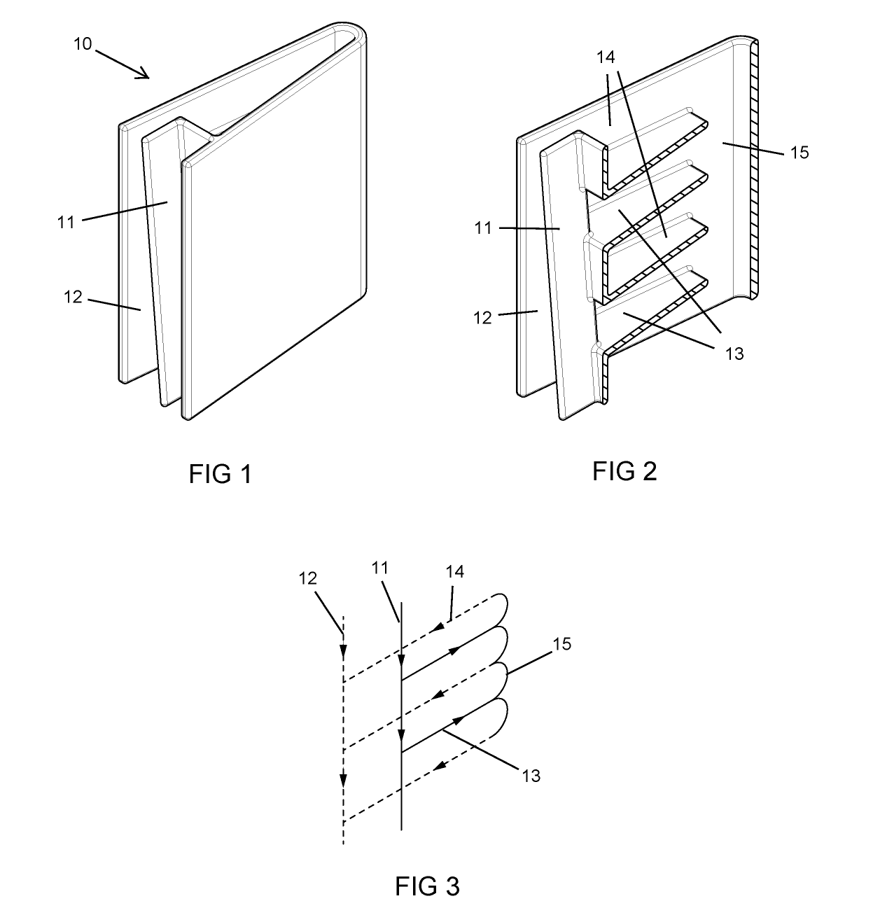

FIG. 1 shows a first embodiment of the turbine airfoil trailing edge cooling circuit 10 of the present invention and includes a cooling air supply channel 11 adjacent to a cooling air return channel 12. Cooling air from outside of the airfoil flows into the supply channel 11 and progressively bleeds off into aftward flowing channels 13 toward the trailing edge of the airfoil all in series. The cooling air from the aftward flowing channels 13 flows into a common channel 15 positioned along the trailing edge, and then turns 180 degrees and flows into the forward channels 14 also all in series. The cooling air from the forward channels 14 all flow into the return channel 12 and then out from the trailing edge region. The cooling air flow in the aftward channels 13 cools the pressure side wall of the airfoil in the trailing edge region. The cooling air flow in the forward flowing channels 14 cools the suction side wall of the airfoil in the trailing edge region. The cooling air that turns 180 degrees in the turn channel 15 cools the thin trailing edge of the airfoil. The supply channel 12 progressively decreases in cross sectional flow are due to the cooling air progressively bleeding off into the aftward flowing channels 13. The return channel 12 progressively increases in cross sectional area flow due to the flow progressively increasing from the forward flowing channels 14. Because the aftward flowing and forward flowing channels are alternating in the spanwise direction of the airfoil, the thin trailing edge can be ½ the width of both of the channel together. Thus, a thinner trailing edge can be formed in the airfoil and cooled.

FIG. 2 shows a cutaway view of the thin trailing edge cooling circuit of FIG. 1. The aft and forward flowing channels 13 and 14 are separated by ribs. In the thin section of the trailing edge, the turn channel 15 is located in which the cooling air from the aft channel 13 turns and flow in the forward channel 14. FIG. 3 shows a flow diagram of the FIG. 1 cooling circuit. FIG. 3 shows the supply and return channels 11 and 12 both flowing downward. However, the return channel 12 could flow upward depending on how the cooling air is removed from the cooling circuit such as in a blade or vane.

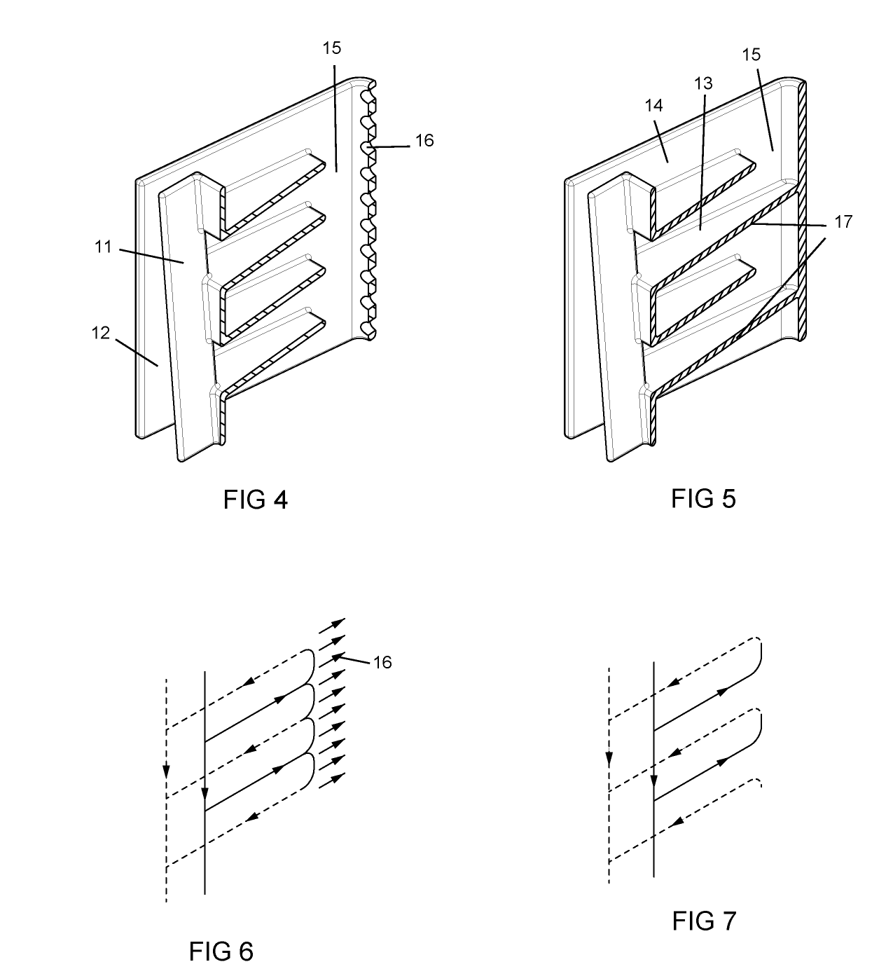

FIG. 4 shows a cutaway view of another version of the cooling circuit of FIG. 1 where a row of exit holes 16 is used along the trailing edge connected to the turn channel 15. FIG. 6 shows a flow diagram of the FIG. 4 cooling circuit.

FIG. 5 shows a cutaway view of another version of the cooling circuit of FIG. 1 where each pair of aft and forward flowing channels is separated from adjacent pairs by a rib 17. FIG. 7 shows a flow diagram for the FIG. 5 cooling circuit.

Because the two series of channels 13 and 14 are alternating in the spanwise direction of the airfoil, the airfoil at the trailing edge can be relatively thin. Also, because of the 180 degree turn channel 15, the trailing edge of the airfoil is very effectively cooled.

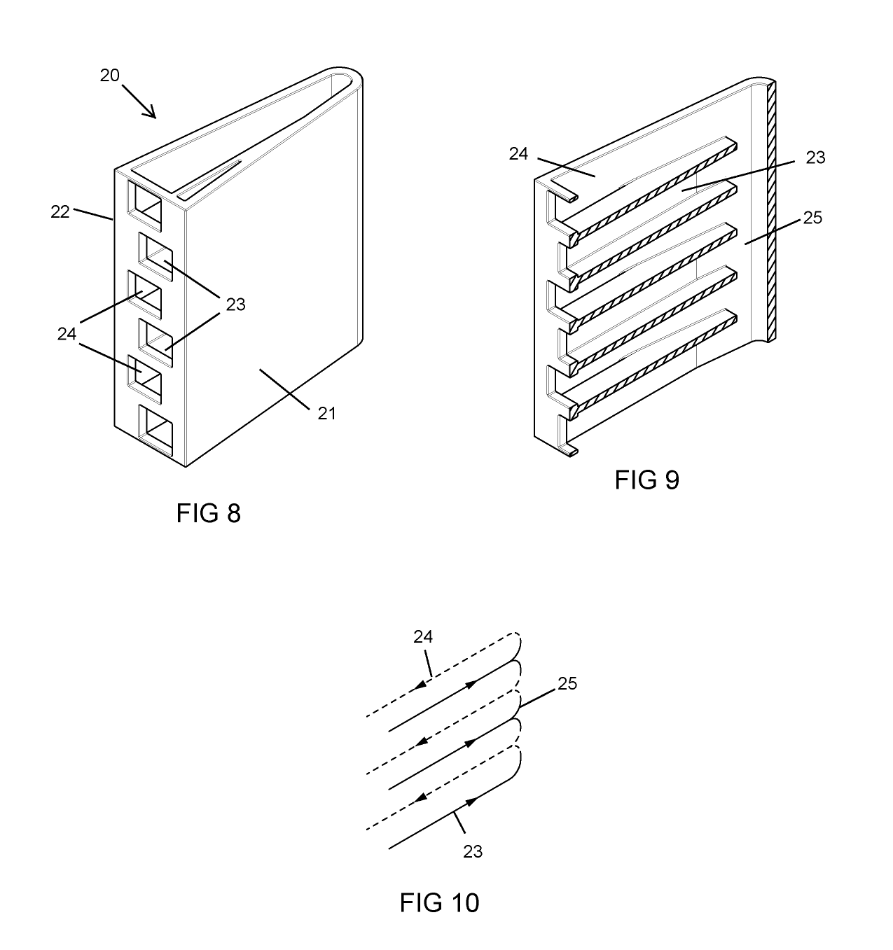

FIG. 8 shows a second embodiment of a thin trailing edge cooling circuit 20 for a thin walled turbine airfoil. The TE cooling circuit 20 includes a pressure side section 21 and a suction side section 22. The pressure side section 21 includes aftward flowing channels 23 while the suction side section 22 includes forward flowing channels 24. The aftward flowing channels 23 alternate in a spanwise direction of the airfoil with the forward flowing channels 24. The aftward flowing channels 23 are connected to the forward flowing channels 24 at a turn channel 25 located at the thin trailing edge of the airfoil. Cooling air from the airfoil (such as a supply channel) flows into the series of aftward flowing channels 23 to cool the pressure side wall of the airfoil in the trailing edge region, then turns in the turn channel 25 at the trailing edge, and then flows in the series of forward flowing channels 24 to cool the suction side wall. Because the two series of channels 23 and 24 are alternating in the spanwise direction of the airfoil, the airfoil at the trailing edge can be relatively thin. Also, because of the 180 degree turn channel 25, the trailing edge of the airfoil is very effectively cooled.

FIG. 9 shows a cutaway view of the cooling circuit of FIG. 8 with alternating aft flowing channels 23 and forward flowing channels 24 with a common turn channel 25 located along the thin trailing edge. FIG. 10 shows a flow diagram for the cooling circuit of FIG. 8.

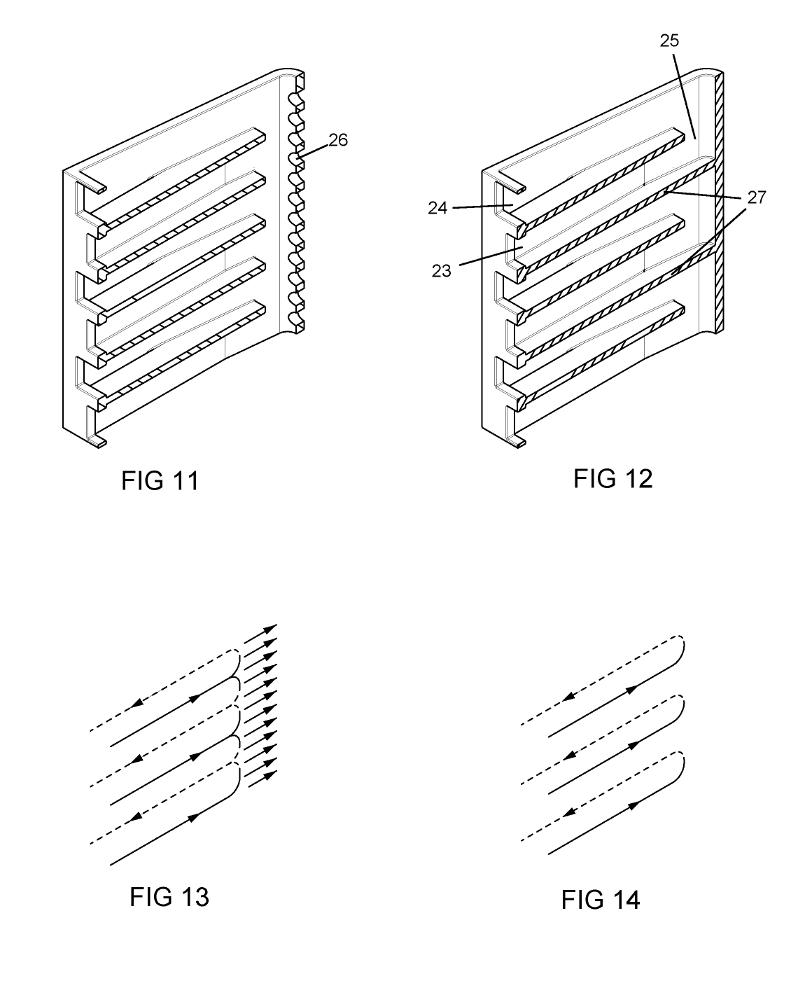

FIG. 11 shows a cutaway view of a second version of the cooling circuit of FIG. 8 in which a row of exit holes 26 are used on the trailing edge connected to the turn channel 25. FIG. 13 shows a flow diagram of the FIG. 11 cooling circuit.

FIG. 12 shows a cutaway view of a third version of the cooling circuit of FIG. 8 in where each pair of aft and forward flowing channels is separated from adjacent pairs by a rib 27. FIG. 14 shows a flow diagram for the FIG. 12 cooling circuit.

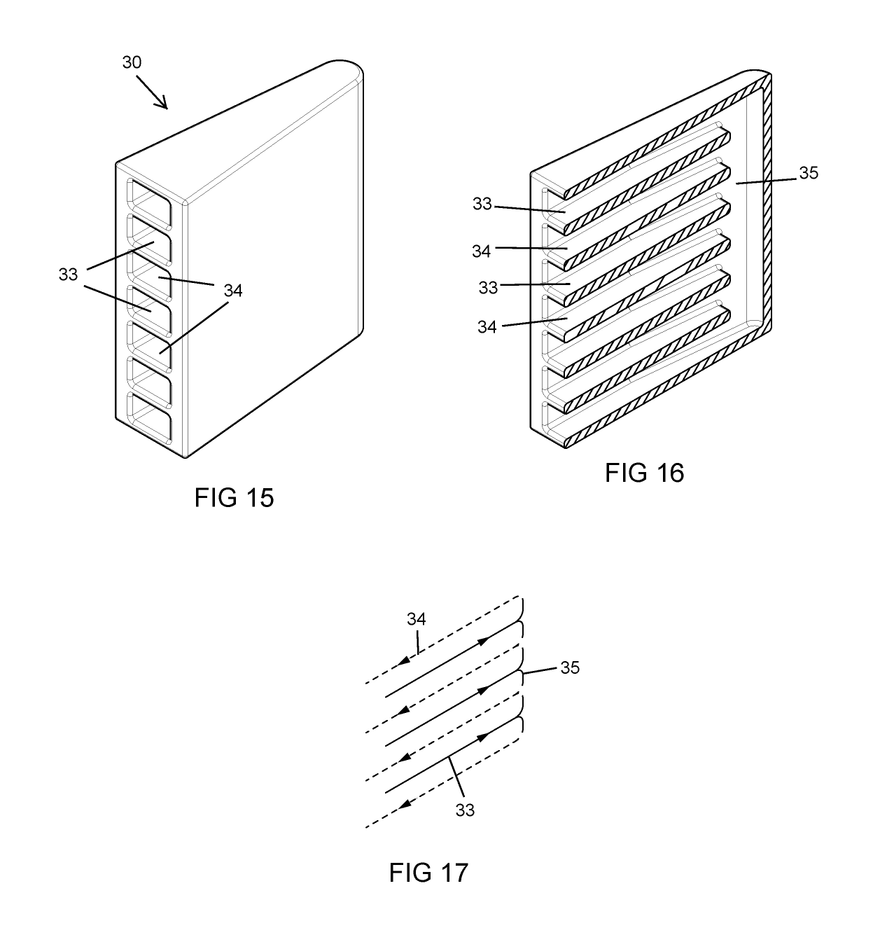

FIG. 15 shows a third embodiment of the thin trailing edge airfoil cooling circuit of the present invention. The TE cooling circuit 30 has a plurality of aftward flowing cooling air channel 33 alternating between an equal numbers of a plurality of forward flowing cooling air channel 34. The aftward flowing channels 33 connect to the forward flowing channels 34 at a turn channel 35 in the thin trailing edge of the airfoil as seen in FIG. 16. In the FIG. 15 embodiment, each of the aftward flowing channels 33 and the forward flowing channels 34 cools both the pressure side wall and the suction side wall of the airfoil in the trailing edge region. Each channel 33 and 34 is narrower at the trailing edge than at the inlets or outlets of the channels 33 and 34. A radial extending supply channel will supply the cooling air to the aft flowing channels 33 and a radial extending exhaust channel will receive the spent cooling air from the forward flowing channels 34. The two radial extending channels (not shown) are offset from one another and have curved or bend channels that connect to the inlets or outlets of the aft and forward flowing channels 33 and 34.

FIG. 17 shows a flow diagram for the cooling circuit of FIG. 15.

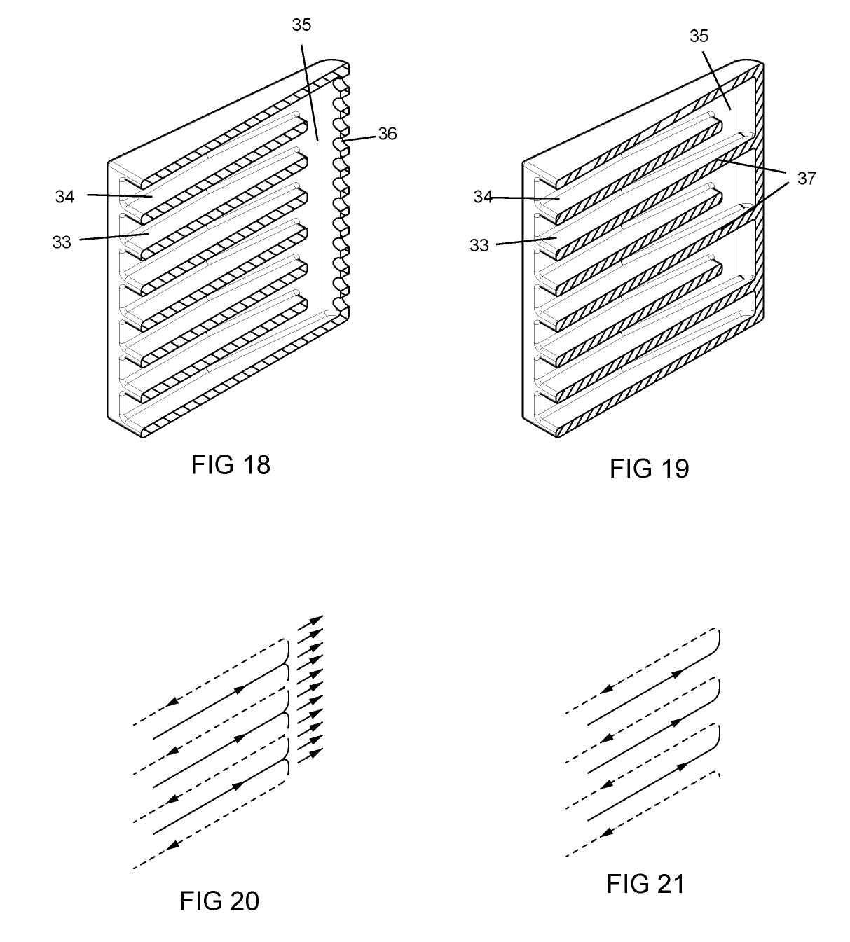

FIG. 18 shows a second version of the cooling circuit of FIG. 15 in which a row of exit holes 36 on the trailing edge of the airfoil is used to discharge some of the cooling air in the turn channel 35. FIG. 20 shows a flow diagram for the cooling circuit of FIG. 18.

FIG. 19 shows a third version of the cooling circuit of FIG. 15 where each pair of aft flowing and forward flowing channels 33 and 34 are separated by a rib 37. FIG. 21 shows a flow diagram for the cooling circuit of FIG. 19.

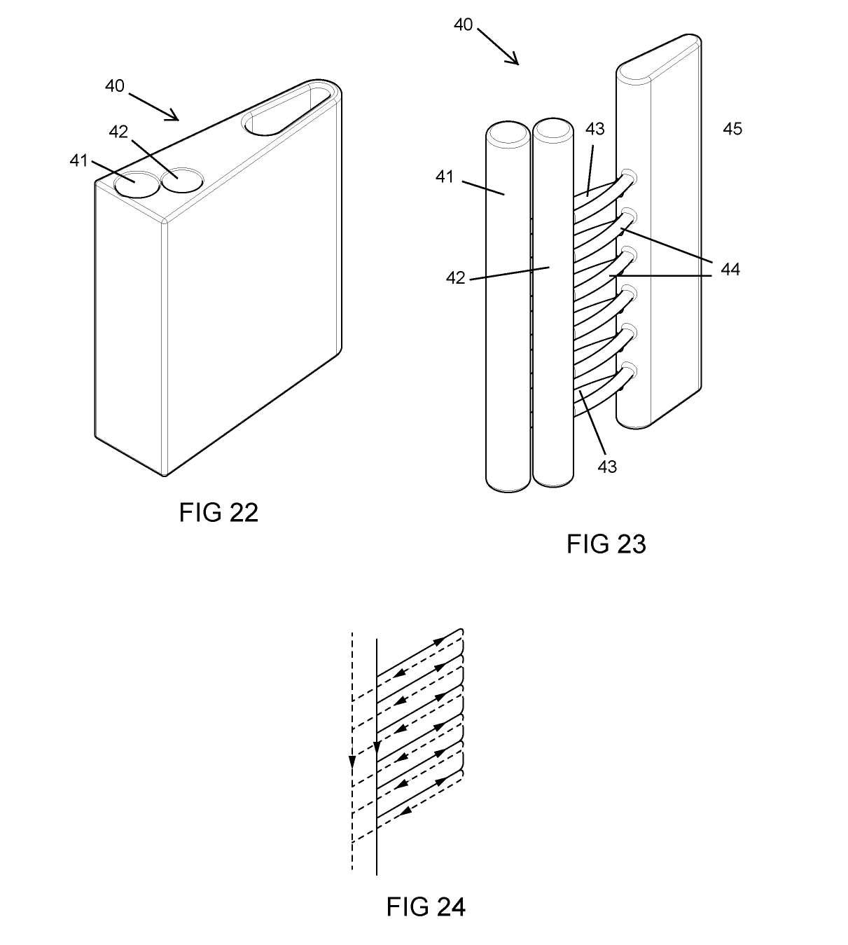

FIG. 22 shows a fourth embodiment of the present invention where the TE cooling circuit 40 includes a cooling air supply channel 41 adjacent to a cooling air return channel 42 where one channel is behind the other channel in order to minimize a width of the airfoil and allow for a thin airfoil wall. A plurality of aftward flowing cooling air channels 43 are connected to the supply channel 41, and a plurality of forward flowing cooling air channels 44 are connected to the return channel 42. A turn channel 45 is located at the trailing edge of the airfoil and connects the aftward flowing channels 43 to the forward flowing channels 44. The TE region cooling circuit 40 operates the same way as the FIGS. 1 and 8 embodiments in that cooling air from the supply channel 41 flows through the plurality of aftward flowing channels 43 to cool the pressure side wall of the airfoil wall, turns in the turn channel 45, and then flows through the plurality of forward flowing channels 44 to cool the suction side wall of the airfoil in the trailing edge region. The cooling air then flows into the return channel 42 and flows to another part of the airfoil or flows out from the airfoil.

FIG. 23 shows a ceramic core used to cast the cooling circuit of the FIG. 22. FIG. 24 shows a flow diagram for the cooling circuit of FIG. 22.

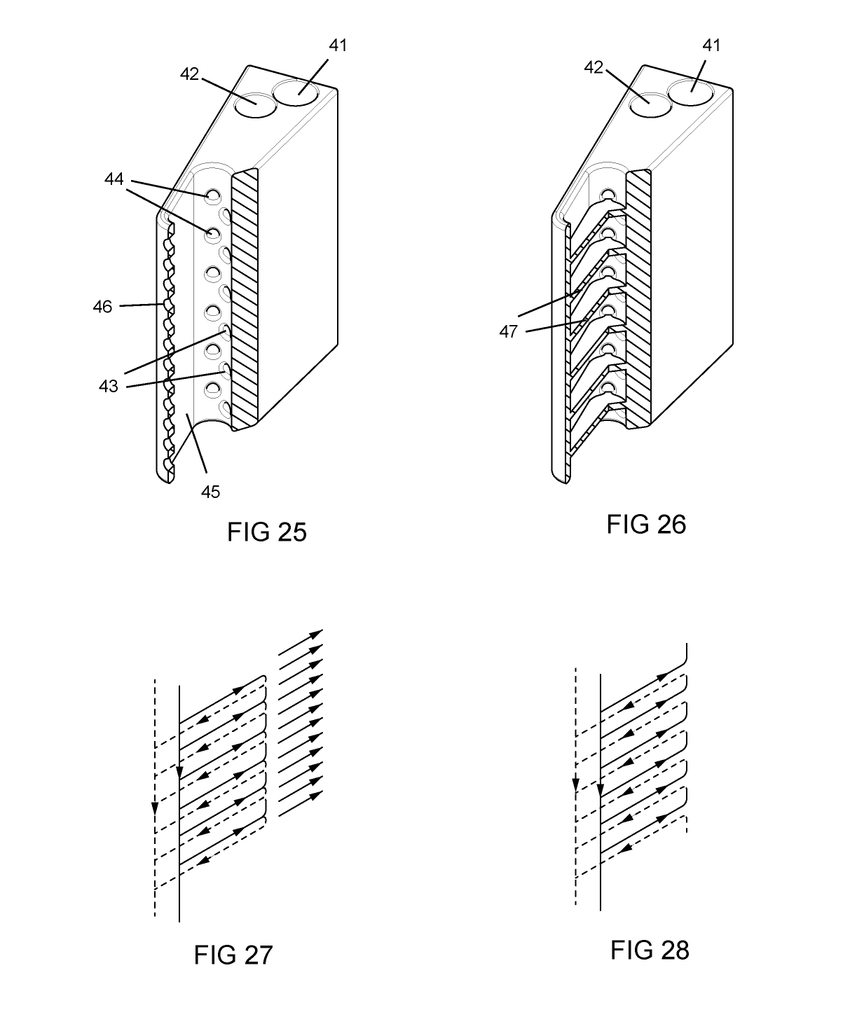

FIG. 25 shows a second version of the cooling circuit of FIG. 22 in which a row of exit holes 46 is used on the trailing edge and connected to the turn channel 45 to discharge some of the cooling air out through the trailing edge. FIG. 27 shows a flow diagram of the cooling circuit of FIG. 25.

FIG. 26 shows a third version of the cooling circuit of FIG. 22 where each pair of aft flowing and forward flowing channels 43 and 44 are separated by ribs 47. FIG. 28 shows a flow diagram for the cooling circuit of FIG. 26.

In all of the embodiments of the trailing edge region cooling circuits except for the embodiment in FIG. 15 have channels that extend along the pressure side wall and the suction side wall with a turn channel at the trailing edge so that cooling air flows first along the pressure side wall, then turns at the trailing edge upward or downward, and then flows along the suction side wall to provide cooling for the PS wall, the TE, and then the SS wall in series. In all of the embodiments (FIGS. 1-28), the trailing edge turn channel could have exit holes therein to discharge some of the cooling air out through the trailing edge, or the TE turn channel can be separate turn channels or one turn channel extending the entire spanwise length of the airfoil. also, each of the embodiments of FIGS. 1-28 can have the cooling air supplied to and discharge from the airfoil in the same direction or in opposite directions. For example, a stator vane could have the cooling air supplied to channel 11 in FIG. 3 from above and discharged from channel 12 below the airfoil to be used for other cooling or sealing. Or, the airflow in the channel 12 could flow back out above the airfoil for use in another stage of stator vanes downstream thereof.

I claim the following:

1. An air cooled turbine airfoil comprising:
an airfoil with a trailing edge region;
a trailing edge region cooling circuit having a plurality of aftward flowing cooling channels and a plurality of forward flowing cooling channels;
the aftward flowing cooling channels alternating between the forward flowing cooling channels;
a turning channel located along a trailing edge of the airfoil; and,
the turning channel connects the forward flowing cooling channels to the aftward flowing cooling channels.

2. The air cooled turbine airfoil of claim 1, and further comprising:
the aftward flowing cooling air channels are connected to a spanwise extending cooling air supply channel;
the forward flowing cooling air channels are connected to a spanwise extending cooling air return channel.

3. The air cooled turbine airfoil of claim 2, and further comprising:
both the cooling air supply channel and the cooling air return channel have a decreasing cross sectional flow area in a direction of cooling air flow.

4. The air cooled turbine airfoil of claim 2, and further comprising:
the cooling air supply channel is positioned in front of or behind the cooling air return channel.

5. The air cooled turbine airfoil of claim 1, and further comprising:
the aftward flowing channels are along a pressure side wall of the airfoil; and,
the forward flowing channels are along a suction side wall of the airfoil.

6. The air cooled turbine airfoil of claim 1, and further comprising:
both the aftward flowing cooling channels and the forward flowing cooling channels extend from a pressure side wall to a suction side wall of the airfoil.

7. The air cooled turbine airfoil of claim 1, and further comprising:
the aftward flowing cooling channels have a decreasing cross sectional flow area; and,
the forward flowing cooling channels have an increasing cross sectional flow area.

8. An air cooled turbine airfoil comprising:
a airfoil with a pressure side wall and a suction side wall;
a trailing edge region with a trailing edge;
a cooling air supply channel located adjacent to the trailing edge region;
a cooling air discharge channel located adjacent to the cooling air supply channel;
a plurality of aftward flowing chordwise extending cooling air channels each connected to the cooling air supply channel;
a plurality of forward flowing chordwise extending cooling air channels connected to the cooling air exhaust channel;
a cooling air turn channel located at the trailing edge of the airfoil; and,
the cooling air turn channel is connected to the plurality of forward flowing chordwise extending cooling air channels;
wherein cooling air from the cooling air supply channel flows through the plurality of aftward flowing chordwise extending cooling air channels and into the trailing edge turn channel, then into the plurality of forward flowing chordwise extending cooling air channels, and then into the cooling air discharge channel.

9. The air cooled turbine airfoil of claim 8, and further comprising:
the trailing edge turn channel is formed of a plurality of separate turn channels with each turn channel connected to one aftward flowing chordwise extending cooling air channel and one forward flowing chordwise extending cooling air channel.

10. The air cooled turbine airfoil of claim 8, and further comprising:
the trailing edge turn channel includes a row of exit holes.

11. The air cooled turbine airfoil of claim 8, and further comprising:
the plurality of aftward flowing chordwise extending cooling air channels are closer to the pressure side wall; and,
the plurality of forward flowing chordwise extending cooling air channels are closer to the suction side wall.

12. The air cooled turbine airfoil of claim 11, and further comprising:
the aftward flowing chordwise extending cooling air channels and the forward flowing chordwise extending cooling air channels all have a curvature inward.

13. The air cooled turbine airfoil of claim 8, and further comprising:
the cooling air supply channel is a radial extending channel that converges in a flow direction of the cooling air; and,
the cooling air discharge channel is a radial extending channel that diverges in a flow direction of the cooling air.
